(19) United States
(12) Patent Application Publication
(10) Pub. No.: US 2007/0180370 A1
(43) Pub. Date: Aug. 2, 2007

(54) System and method for sequencing pages in a document processing device

(75) Inventors: Man Mohan Garg, Cerritos, CA (US); Rohit Wadhwa, Lebanon, NH (US); Rahul Padalikar, Bangalore (IN)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/346,461

(22) Filed: Feb. 2, 2006

(51) Int. Cl. G06F 15/00

(52) U.S. Cl. 715/526

(57) ABSTRACT

A system and method for sequencing pages in a document processing device which is capable of implementation on any type of document processing device. The method begins with the receipt of document data representing a series of pages for output by an associated document rendering device, device data representing document output capabilities corresponding to the document rendering device, and instruction data representing duplex, collating and number of copies associated the document data. Page sequencing data is then generated, via a page sequencer, for associating each page of received document data with a document face in an output thereof by the associated document rendering device in accordance with the document data. Face sequencing data is also generated, via a face sequencer, for relative association of document faces in pages of an output of the associated document rendering device in accordance with received instruction data. In addition, sheet sequencing data is generated, via a sheet sequencer, for ordering output of sheets in the associated document rendering device in accordance with received device data.

### BACKGROUND OF THE INVENTION

This invention is directed to a system and method for sequencing pages in a document processing device. More particularly, this invention provides a system and method for sequencing pages in the proper order based on the document processing options selected and the capabilities of the document processing device. The system and method of the present invention are able to be implemented on any type of document processing device.

Document processing devices are typically capable of generating documents in multiple formats, such as duplex mode, multiple pages per sheet, and booklet mode. Some of the formatting options, such as duplexing, require the pages to be reorganized during processing. This reorganization of pages is very dependent on the capabilities of the document processing device and the options selected by the user when requesting the processing job. Determining the correct sequence in which the pages should be sent to the document processing device to ensure the correct output can be quite complex and time consuming, especially if the user has requested multiple formats for a processing job. The complexity of determining the correct sequence is exacerbated if the job should be aborted for some reason, and then must be restarted at the proper location in the processing and with the correct sequencing to correctly complete the job.

One solution is to generate an algorithm for feeding pages to a document processing device based on the job options available on the device and the device capabilities. However, the implementation of such algorithms requires a large amount of code to be created, and then stored. Also, the code must be updated should the job options or device capabilities be modified. Further, such code does not usually provide a standard method for recovering from an error or an aborted processing job. Therefore, there is a need for an improved system and method for sequencing pages in a document processing device.

The subject invention provides a system and method for sequencing pages in the proper order based on the document processing options selected and the capabilities of the document processing device.

### SUMMARY OF THE INVENTION

In accordance with the present invention, there is provided a system and method for sequencing pages in a document processing device.

Further, in accordance with the present invention, there is provided a system and method for sequencing pages in the proper order based on the document processing options selected and the capabilities of the document processing device.

Further, in accordance with the present invention, there is provided a system and method for sequencing pages in a document processing device which may be implemented on any type of document processing device.

Still further, in accordance with the present invention, there is provided a system for sequencing pages in a document processing device. The system includes means adapted for receiving document data representative of a series of pages for output by an associated document rendering device, means adapted for receiving device data representative of document output capabilities of the associated document rendering device, and means adapted for receiving instruction data representative of at least one of duplex, collating and number of copies associated the document data. The system also includes a page sequencer, a face sequencer, and a sheet sequencer. The page sequencer includes means adapted for generating page sequencing data for associating each page of received document data with a document face in an output thereof by the associated document rendering device in accordance with the document data. The face sequencer comprises means adapted for generating face sequencing data for relative association of document faces in pages of an output of the associated document rendering device in accordance with received instruction data. The sheet sequencer includes means adapted for generating sheet sequencing data for ordering output of sheets in the associated document rendering device in accordance with received device data.

Still further, in accordance with the present invention, there is provided a method for sequencing pages. The method receives document data representative of a series of pages for output by an associated document rendering device, device data representative of document output capabilities of the associated document rendering device, and instruction data representative of at least one of duplex, collating and number of copies associated the document data. Page sequencing data is then generated, via a page sequencer, for associating each page of received document data with a document face in an output thereof by the associated document rendering device in accordance with the document data. Face sequencing data is also generated, via a face sequencer, for relative association of document faces in pages of an output of the associated document rendering device in accordance with received instruction data. In addition, sheet sequencing data is generated, via a sheet sequencer, for ordering output of sheets in the associated document rendering device in accordance with received device data.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram of the system according to the present invention; and

FIG. 2 is a flowchart illustrating a method for sequencing pages according to the present invention;

FIG. 3 is a flowchart illustrating a method for generating page sequencing data according to the present invention;

FIG. 4 is a flowchart illustrating a method for generating face sequencing data according to the present invention; and

FIG. 5 is a flowchart illustrating a method for generating sheet sequencing data according to the present invention.

### DETAILED DESCRIPTION OF THE PREFERRED EMBODIMENT

This invention is directed to a system and method for sequencing pages in a document processing device. In particular, this invention is directed to a system and method for sequencing pages in the proper order based on the document processing options selected and the capabilities of the document processing device. More particularly, this invention is directed to a system and method for sequencing pages in a document processing device which is capable of implementation on any type of document processing device. In accordance with the present invention, as used herein, a document processing device is any suitable electronic device, known in the art, capable of providing one or more document processing services. In the preferred embodiment, as described herein, the document processing device is suitably an image generating device. Preferably, the image generating device is a multifunctional peripheral device, capable of providing scanning, copying, facsimile, printing, document management, document storage, electronic mail, and other fictions to a user.

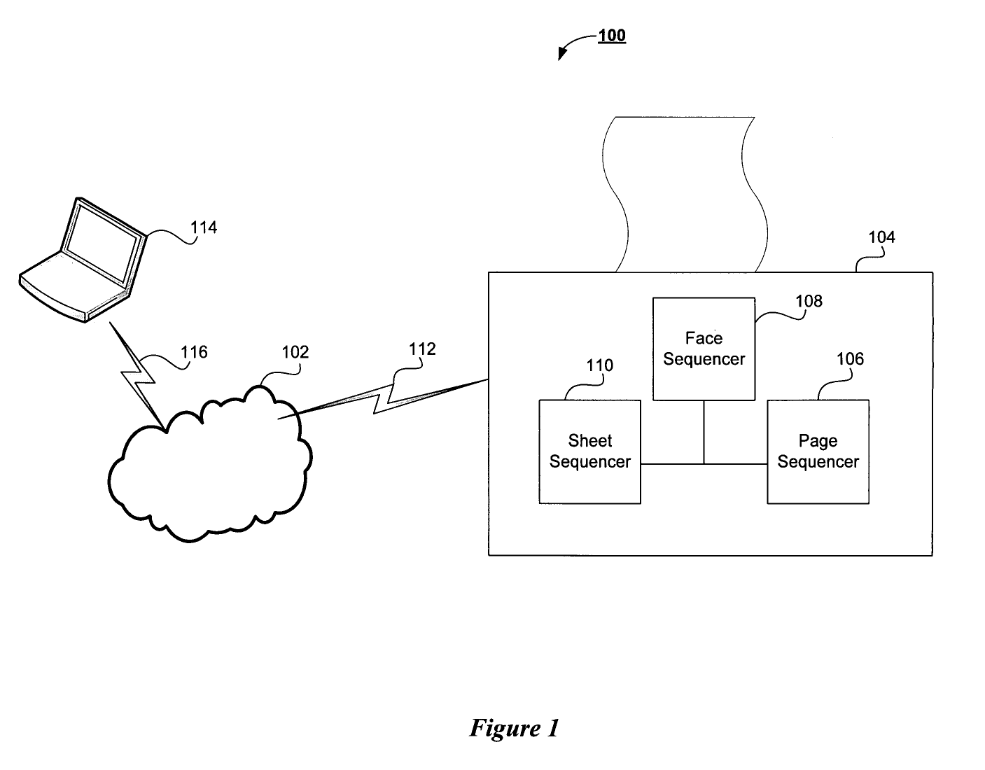

Turning now to FIG. 1, there is shown a block diagram illustrating a system 100 in accordance with the present invention. It is to be appreciated by those skilled in the art that the system 100 described in FIG. 1 is for example purposes only. As shown in FIG. 1, the system 100 is implemented using a distributed computing environment, illustrated in FIG. 1 as the computer network 102. In the preferred embodiment, the computer network 102 is any computer network known in the art capable of enabling communications between two or more electronic devices. As will be understood by those skilled in the art, the subject invention is capable of implementation over any suitable computer network, including, for example and without limitation, a personal area network, a local area network, a wide area network, Token Ring network, Ethernet-based network, an intranet, the Internet, or any combination thereof.

As shown in FIG. 1, the system 100 further includes a document processing device 104. It will be appreciated by those skilled in the art that the document processing device 104 is represented in FIG. 1 as a multifunction peripheral device, advantageously adapted to provide a variety of document processing services, including, for example and without limitation, copying, printing, facsimile, storage, electronic mail, scanning, and the like. Suitable commercially available image generating devices include, but are not limited to, the Toshiba e-Studio Series Controller. The document processing device 104 includes a page sequencer component 106, suitably adapted to facilitate the processing of n-Up options selected and magazines designated in a document processing request. As will be understood by those skilled in the art, page sequencer component 106 is suitably configured to determine the proper placement of faces on a page of a document. The document processing device 104 further includes a face sequencer component 108, suitably adapted to facilitate the processing of collation operations, number of copies generated, and duplexing operations to be performed in accordance with a received document processing request. As will be appreciated by those skilled in the art, the face sequencer component 108 is suitably configured to determine the proper placement of pages on a sheet of output media. In addition, the document processing device 104 incorporates a sheet sequencer component 110 suitably adapted to facilitate the incorporation of device specific capabilities into the output sequencing of a document processing request. As will be understood by those skilled in the art, device specific capabilities include, for example and without limitation, the capacity of an input tray, the holding capacity of an output tray, the finishing options available on the device, the capacity of the intermediate holding tray for duplex printing, the maximum resolution available on the scanner, the paper media available, and the like.

The document processing device 104 is in communication with the computer network 102 via a communications link 112. As will be understood by those skilled in the art, the communications link 112 is any suitable communications channel known in the art including, for example and without limitation, Bluetooth, WiMax, 802.11a, 802.11b, 802.11g, 802.11(x), infrared, optical, or any suitable wireless data transmission system, or wired communications known in the art. In the preferred embodiment of the present invention, the document processing device 104 further includes a user-interface, thereby enabling direct interaction between an associated user and the document processing device 104. More preferably, the user-interface is a touch-screen interface, however any other suitable means of user interaction, such as an alphanumeric keypad, mouse, LCD, or any combination thereof, are equally capable of being employed to receive instructions from the user. In one particular embodiment of the present invention, the document processing device 104 is advantageously equipped to receive a plurality of portable storage media, including without limitation, Firewire drives, USB drives, SD, MMC, XD, Compact Flash, Memory Stick, and the like. The skilled artisan will appreciate that the combination of the user-interface and the portable storage media enables an associated user to request document processing services without accessing the computer network 102.

The system 100 depicted in FIG. 1 further includes at least one client device 114, illustrated in FIG. 1 as a notebook computer. It will be appreciated by those skilled in the art that the depiction of the client device 114 as a notebook computer is for example purposes only and the client device 114 is capable of being any personal electronic device known in the art capable of communication with the document processing device 104 via the computer network 102. Suitable client devices include, for example and without limitation, desktop computers, personal data assistants, web-enabled cellular telephones, and the like. As shown in FIG. 1, the client device 114 advantageously communicates with the computer network 102 via a suitable communications link 116. As will be understood by the skilled artisan, the communications link 116 is any communications channel known in the art, including, for example and without limitation, infrared, optical, WiMax, 802.11a, 802.11b, 802.11g, 802.11(x), Bluetooth, or any suitable wireless data transmission system or wired communications known in the art

In accordance with the present invention, the document processing device 104 receives a document processing request from the client device 114 via the computer network 102. It will be understood by those skilled in the art that the instant invention enables the origination of a document processing request at the document processing device 104 itself, via user intervention at the user-interface. For example and without limitation, a user is able to select a an electronic document from a portable storage media, scan a hardcopy to generate electronic document data, retrieve an electronic file from a remote storage location, select an attachment to an electronic mail message, and the like. In the preferred embodiment, the document processing request includes electronic document data representative of an electronic document on which document processing operations are to be performed, and document processing instruction data representative of document processing operations and options as selected by the user. It will be appreciated by those skilled in the art that an associated user of the client device 114 advantageously selects the electronic document, document processing operations, and document processing options via an application resident on the client device 114, or alternatively via selections made at the user-interface associated with the document processing device 104.

Upon receipt of the document processing request, the specific capabilities of the document processing device 104 are ascertained via any suitable means. Preferably, the specific capabilities included, but are not limited to, the finishing options capable of being performed by the document processing device 104, the types of paper media available at the device 104, the processing components resident on the device 104, e.g., optical character recognition, voice to text conversion, and the like, as well as the various toners and output options selectable by the user. The received document processing request is then forwarded to the page sequencer component 106 so as to generate page sequence data.

The page sequencer component 106 analyzes the document processing request and determines whether the received request includes metadata associated with the document processing request. When no metadata exists, the page sequencer component 106 then uses the document processing instructions to determine any n-Up function or magazine sort to be performed on the received electronic document. In the event that metadata is already present in the document processing request, the page sequencer component 106 processes the metadata to determine the n-Up and magazine sort to be performed on the document. Using specific algorithms with respect to the n-Up sort and the magazine sort, a value is assigned to a Page Number associated with each Face Number based on these algorithms. The skilled artisan will appreciate that the foregoing operation enables the page sequencer component 106 to determine which pages of a document will be printed on each face of the final document. Next, updated metadata is generated reflecting the assigned Page Number values, or page sequence data, and forwarded on to the face sequencer component 108.

The face sequencer component 108 is configured to facilitate the duplex, collate, and number of copies options for the document processing request. Upon receipt of the updated metadata, the face sequencer component 108 is tasked with a series of determinations, with the outcomes of such determinations affecting the values assigned to each Sheet Number, or face sequence data. Thus, the face sequencer component 108 first determines whether multiple copies have been requested. When multiple copies have been requested, a Sheet Number value is assigned to each page based on the number of copies selected. When no multiple copies have been requested, the face sequencer component 108 determines whether or not the document processing request requires duplex printing, i.e., printing on the front and back of a sheet of paper. When no duplex has been requested, the metadata is updated to reflect the Sheet Number values associated with each page of the electronic document, i.e., face sequence data, and the face sequencer component 108 forwards the face sequence data to the sheet sequencer component 110.

When multiple copies have been selected, the face sequencer component 108 then determines whether the sort collate option has been selected. It will be appreciated by those skilled in the art that the sort collate option enables multiple copies to be outputted as a set, i.e., pages 1-4 are printed for the first copy and then pages 1-4 are printed for the second copy, and so on. In contrast, group sort collating indicates that, for example, when 4 copies are requested, page 1 is printed four times, then page 2 is printed four times, and so on until page 4 has been printed four times. When sort collating is requested, the face sequencer component 108 adjusts the Sheet Number value associated with the Page Number value reflecting the sort collating request. When sort collation is not requested, the face sequencer component 108 then adjusts the Sheet Number value to reflect the group collate option.

Irrespective of the collate option selected, the face sequencer component 108 next determines whether or not duplex, e.g., double-sided printing, has been selected. When duplex has been selected, the Sheet Number value is adjusted to reflect the duplex selection. When no duplex has been requested, the metadata is updated to reflect the Sheet Number values associated with each page of the electronic document, i.e., face sequence data, and the face sequencer component 108 forwards the face sequence data to the sheet sequencer component 110.

Upon receipt of the updated metadata, or face sequence data, from the face sequencer component 108, the sheet sequencer component 110 determines the device capability data and retrieves the document processing instruction data relating to the document processing request. It will be appreciated by those skilled in the art that the sheet sequencer component 110 is tasked with determining whether any conflict exist between the sequence previously calculated, i.e., the page sequence data and the face sequence data, and the capabilities of the device 104 which is processing the document processing request. That is to say, the sheet sequencer component 110 determines whether any adjustments are needed to the sequence data so as to allow the device 104 to process the document processing request. Any component incompatibilities, size limitations, media limitations, finishing option limitations, and the like, are determined by the sheet sequencer component 110.

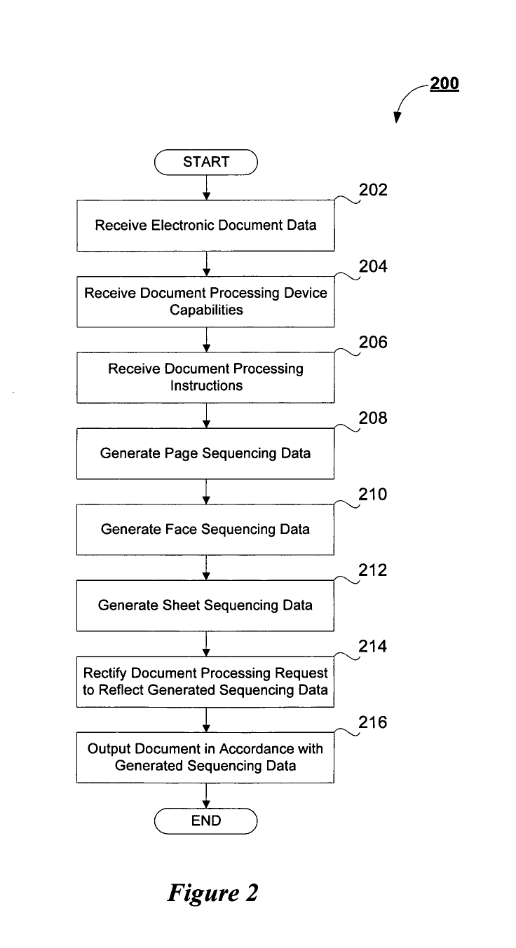

The sheet sequencer component 110 first determines whether a conflict exists between the device capabilities and the duplex option selected. When a conflict exists, the Sheet Number for each page is modified so as to rectify the conflict and enable the document to be output by the document processing device 104. When no conflict between the device capabilities and the duplex printing option have been found, the sheet sequencer component 110 then determines whether an input tray conflict exists. For example, the received print options are capable of specifying a paper media not available on the device 104, a color toner not available, and the like. The input tray conflict is then alleviated by the sheet sequencer component 110, which adjusts the values of the sheetNumbers of the affected pages of the electronic document. When an output tray conflict is detected, the sheetNumbers of the affected pages are adjusted in order to overcome the conflict. Once all conflicts have been corrected, including finishing option conflicts, and all sheetNumbers have been updated or revised to reflect changes designated by the sheet sequencer component 110, the updated metadata is returned to the document processing device 104 main processing component (not shown). The document processing device 104 then outputs the document processing request in the manner designated by the sequence referenced by the sheetNumbers, pageNumbers, and faceNumbers contained in the associated metadata. The foregoing description of an example system will better be understood by those skilled in the art when viewed in conjunction with the methods found in FIGS. 2, 3, 4, and 5, described hereinafter.

Referring now to FIG. 2, there is shown a flowchart 200 illustrating a method for sequencing pages in accordance with the present invention. In the preferred embodiment described herein, the method is performed by a hardware, software, or suitable combination thereof, component resident on the document processing device 104. More preferably, an application resident on the document processing device 104 functions to implement the method as described herein. As depicted in FIG. 2, the method begins at step 202, whereupon the document processing device 104 receives electronic document data representative of an electronic document for output by the document processing device 104. It will be understood by those skilled in the art that the electronic document data is advantageously included within a document processing request, which further contains document processing instructions representative of selected operations and options for performance upon the electronic document by the document processing device 104. Next, the application resident on the document processing device 104 ascertains the specific device capabilities associated therewith at step 204. At step 206, the document processing instructions are analyzed by the application so as to enable further processing of the electronic document by the page sequencer component 106, the face sequencer component 108, and the sheet sequencer component 110.

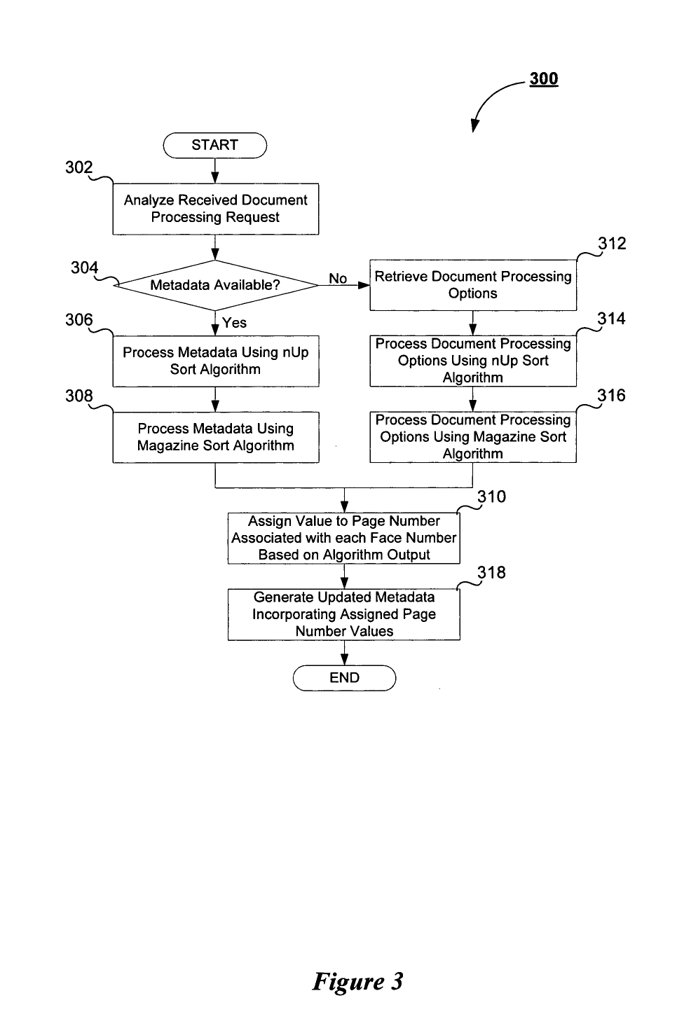

At step 208, page sequence data is generated by the page sequencer component 106 in accordance with the method illustrated by the flowchart 300 of FIG. 3. Turning now to FIG. 3, there is shown a method for generating page sequencing data in accordance with the present invention. The method begins at step 302 with the analysis of the received document processing request. At step 304, a determination is made whether metadata associated with the electronic document already exists. When metadata has been received within the document processing request, flow proceeds to step 306, wherein the metadata is processed according to an n-Up sort algorithm. Next, the metadata is processed at step 308 according to a magazine sort algorithm. Following this processing by the page sequencer component 106, flow proceeds to step 310, whereupon a value is assigned to a Page Number associated with each Face Number corresponding to each page of the electronic document. Updated metadata, or page sequence data, is thereafter generated reflecting the Page Number values associated with each Face Number of the original electronic document.

For example, an electronic document contains pages 1-20 when viewed via a suitable word processing application. When a user desires to print more than one page to a sheet of paper, the number of pages, or Face Number, of the electronic document does not change, but the output sheet, i.e., the Page Number, on which the selected number of pages is to be output does change. Continuing with this example, Table 1 illustrates a user selection whereby four pages of an electronic document are to be printed on a single sheet of output media, i.e., 4-Up printing.

TABLE 1

| Face Number | Page Number |
|---|---|
| 1 | 1 |
| 2 | 1 |
| 3 | 1 |
| 4 | 1 |
| 5 | 2 |
| 6 | 2 |
| 7 | 2 |
| 8 | 2 |

Thus, as shown in Table 1, pages 1-4 of the original electronic document are assigned Page Number value of 1, indicating that each face (original electronic document page) is to be output on page 1 of the final hardcopy output. Similarly, pages 5-8 of the original electronic document are assigned a Page Number value of 2, indicating that each face is to be output on page 2 of the final hardcopy output.

Returning to step 304, when no such metadata exists, flow proceeds to step 312, wherein the page sequencer component 106 retrieves document processing options contained within the received document processing instructions. It will be understood by those skilled in the art that the document processing instructions advantageously include user selection information as to the number of pages of original document per sheet of output media that is to be set in the final hardcopy output. Using this information, the page sequencer component 106 initiates an n-Up sort algorithm to ascertain a value for a Page Number to be associated with each Face Number of the original electronic document. Flow then proceeds to step 316, whereupon the page sequencer component 106 applies a magazine sort algorithm to determine a value for a Page Number to be associated with each Face Number of the original electronic document.

Following this processing by the page sequencer component 106, flow proceeds to step 310, whereupon the value is assigned to a Page Number associated with each Face Number corresponding to each page of the electronic document. Updated metadata, or page sequence data, is thereafter generated reflecting the Page Number values associated with each Face Number of the original electronic document.

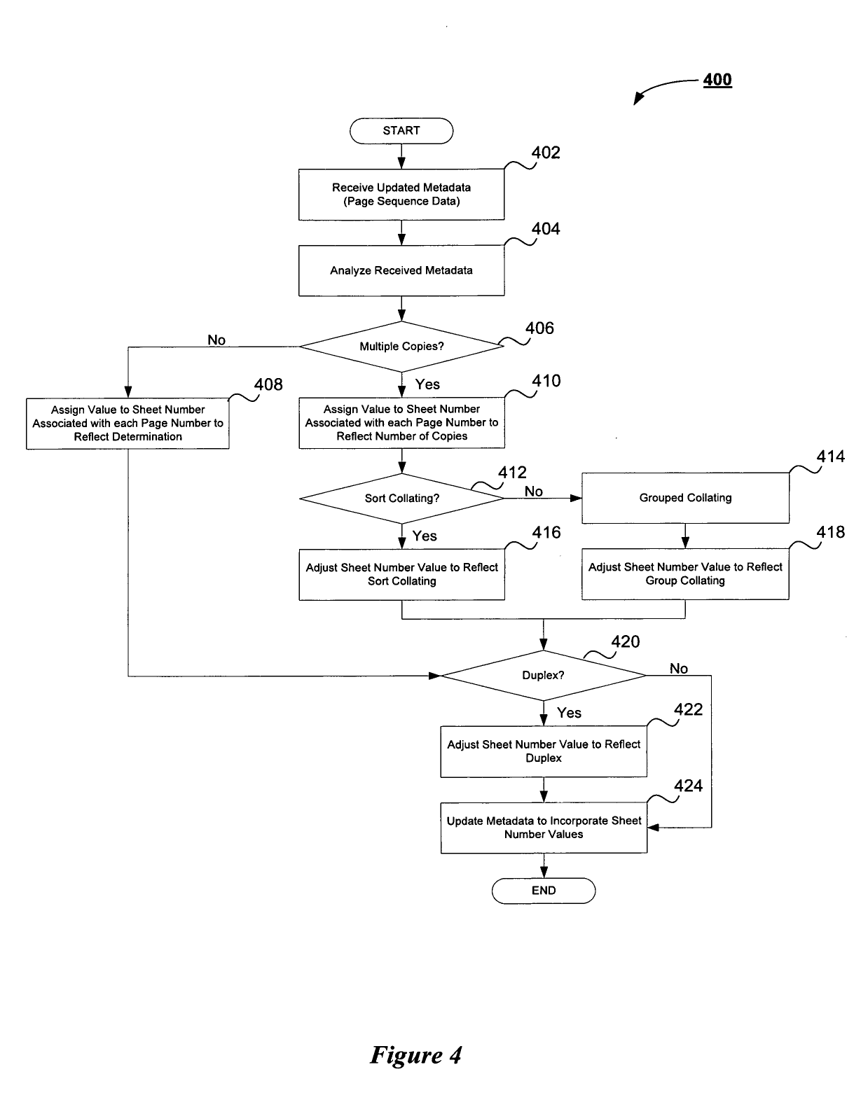

Returning to the flowchart 200 of FIG. 2, once the page sequencing data has been generated at step 208, flow proceeds to step 210, wherein face sequence data is generated by the face sequencer component 108 in accordance with the method illustrated by the flowchart 400 of FIG. 4. Turning now to FIG. 4 is a method for generating face sequencing data in accordance with the present invention. The method begins at step 402 with the receipt of the page sequencing data, or updated metadata, by the face sequencer component 108. At step 404, the received data is analyzed to determine at step 406 whether multiple output copies of the original electronic document have been requested by the associated user. When multiple copies have not been selected by the associated user, flow proceeds to step 408, wherein a value is assigned to a Sheet Number associated with each Page Number based on the single copy determination. Flow then progresses to step 420, whereupon a determination is made whether duplex, i.e., double-sided output, has been selected by the associated user. When duplex has not been selected, flow proceeds to step 424, whereupon the metadata is updated to reflect the assigned Sheet Number values corresponding to associated Page Number values, thereby generating the desired face sequence data.

Referring back to step 406, when it is determined that multiple copies have been selected by the associated user, flow proceeds to step 410, wherein a value is assigned to each Sheet Number correspondingly associated with each Page Number contained within the received metadata. It will be understood by those skilled in the art that the values so generated are based on the number of copies selected by the user. Flow then proceeds to step 412, wherein a determination is made whether the user has selected the sort option. In accordance with the present invention, the sort option is a collating option, which enables multiple copies to be outputted as a set, i.e., pages 1-4 are printed for the first copy and then pages 1-4 are printed for the second copy, and so on. When the sort option has been selected, the Sheet Number values are adjusted for each Page Number so as to reflect the sort collating option. When sort is not selected at step 412, a determination is made at step 414 that the group sorting option has been selected. In accordance with the present invention, the group sorting option is a collating option, which outputs each page in a group before proceeding to output the next page in the document. Thus, for example and without limitation, when 4 copies are requested, page 1 is printed four times, then page 2 is printed four times, and so on until page 4 has been printed four times. Following the determination at step 414, the Sheet Number values are adjusted accordingly to reflect the group sort option at step 418. Irrespective of the type of collating selected, flow proceeds to step 420 for duplex determination.

At step 420, a determination is made whether double-sided output, i.e., duplex output, has been selected. When duplex has not been selected, flow proceeds to step 424, whereupon the metadata is updated to reflect the Sheet Number values assigned and calculated in accordance with the instant invention, so as to generate the desired face sequencing data. When duplex output has been selected, flow proceeds to step 422, whereupon the Sheet Number values are correspondingly adjusted to reflect the determined output order of the pages based on the determinations made at step 420. Flow then proceeds to step 424, whereupon the adjusted Sheet Number values are incorporated into updated metadata, or face sequence data. The foregoing method will better be understood in light of the examples that follow in Tables 2, 3, and 4.

Table 2 illustrates an example wherein the associated user has selected two copies of an original four-page document, single-sided printing, and sorted:

TABLE 2

| Page Number | Sheet Number |
|---|---|
| 1 | 1 |
| 2 | 2 |
| 3 | 3 |
| 4 | 4 |
| 1 (2^{nd} copy) | 5 |
| 2 (2^{nd} copy) | 6 |
| 3 (2^{nd} copy) | 7 |
| 4 (2^{nd} copy) | 8 |

Thus, Table 2 denotes a four-paged document that will output as pages 1-4, each on separate sheets, and then a second copy of the four-paged document will be output, again on separate sheets. The skilled artisan will appreciate that the foregoing example results in two copies of four sheets of paper media, however each page is capable of including a number of faces, depending upon the faceNumbers associated with each Page Number.

Table 3 illustrates an example wherein the associated user has selected three copies of an original two-page document, single-sided printing, and grouped:

TABLE 3

| Page Number | Sheet Number |
|---|---|
| 1 | 1 |
| 1 (2^{nd} copy) | 2 |
| 1 (3r^{d} copy) | 3 |
| 2 | 4 |
| 2 (2^{nd} copy) | 5 |
| 2 (3^{rd} copy) | 6 |

### Thus, Table 3 denotes a two-paged document that will have page 1 outputted three times, each output on a separate sheet of paper media, followed thereafter by page 2, which will be outputted three times, each again on a separate sheet of paper media.

Table 4 illustrates an example wherein the associated user has selected three copies of an original 4-page document, duplex printing, and grouped:

TABLE 4

| Page Number | Sheet Number |
|---|---|
| 1 | 1 |
| 2 | 1 |
| 1 (2^{nd} copy) | 2 |
| 2 (2^{nd} copy) | 2 |
| 1 (3r^{d} copy) | 3 |
| 2 (3^{rd} copy) | 3 |
| 3 | 4 |
| 4 | 4 |
| 3 (2^{nd} copy) | 5 |
| 4 (2^{nd} copy) | 5 |
| 3 (3r^{d} copy) | 6 |
| 4 (3r^{d} copy) | 6 |

Thus, Table 4 denotes a four-paged document that will be duplex printed, that is pages 1 and 2 are printed on the first sheet, front and back respectively, again on the second sheet, front and back, respectively, and a final time on the third sheet, front and back, respectively. Next, pages 3 and 4 are printed, front and back, respectively, in the same manner until three copies have been output. The skilled artisan will appreciate that such output results in six total sheets, with pages 1 and 2 output on the first three sheets, and pages 3 and 4 output on the second three sheets.

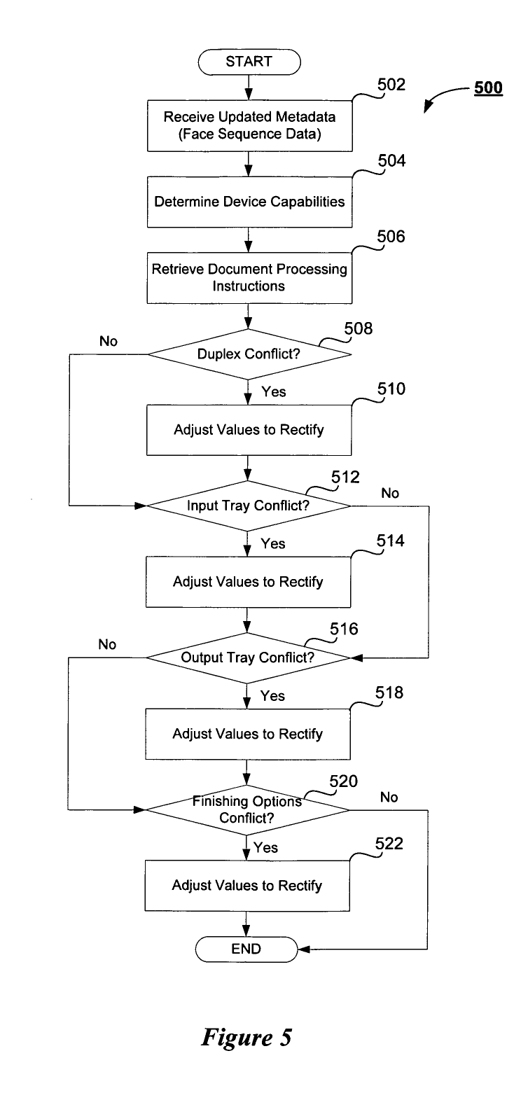

Returning to the flowchart 200 of FIG. 2, once the face sequencing data has been generated at step 210, flow proceeds to step 212, wherein sheet sequence data is generated by the sheet sequencer component 110 in accordance with the method illustrated by the flowchart 500 of FIG. 5. Turning now to FIG. 5, there is shown a method for generating sheet sequencing data according to the present invention. The method begins at step 502 with the receipt of the face sequence data, or metadata, generated by the page sequencer component 108. At step 504, the sheet sequencer component 110 determines the specific device capabilities associated with the document processing device 104. It will be understood by those skilled in the art that the specific capabilities included, but are not limited to, the finishing options capable of being performed by the document processing device 104, the types of paper media available at the device 104, the processing components resident on the device 104, e.g., optical character recognition, voice to text conversion, and the like, as well as the various toners and output options selectable by the user. At step 506, the sheet sequencer component 110 then retrieves the document processing instructions provided by the associated user.

A determination is then made at step 508 whether a conflict exists between the face sequencing data and the device capabilities. That is, the sheet sequencer component 110 determines whether the specific document processing device 104 is capable of performing the selected duplex operation. When it is determined that a conflict exists at step 510, the sheet sequencer component 110 adjusts the metadata to correct or rectify the conflict, enabling further processing by the document processing device 104 and flow proceeds to step 512. When it is determined that the document processing device 104 is capable of performing the desired operation, flow proceeds to step 512, wherein a determination is made whether an input tray conflict exists. When an input tray conflict is determined to exist, the sheet sequencer component 110 updates the metadata, or face sequence data, at step 514 so as to rectify the conflict, enabling further processing by the document processing device 104. When no conflict is detected at step 512, flow proceeds to step 516 wherein an analysis is made by the sheet sequencer component 110 to determine whether an output tray conflict exists. When a conflict exists, flow proceeds to step 518, wherein the metadata is updated to rectify the conflict. Once rectified, flow proceeds to step 520. When no conflict is detected at step 516, flow proceeds to step 520, whereupon a determination is made whether a conflict exists between the device 104 finishing capabilities and the requested finishing options designated by the document processing request. When no conflict exists, the updated metadata, or sheet sequence data, is returned to the document processing device 104 for further processing. When a conflict is detected between the selected document finishing options and the finishing capabilities of the document processing device 104, flow proceeds to step 522, wherein the sheet sequencing data is updated to rectify the conflict and enable the document processing device to complete document processing operations.

Returning to FIG. 2, the updated sheet sequencing data is then used by the document processing device 104 at step 214 to rectify any remaining discrepancies between the document processing request and the capabilities of the document processing device 104. The electronic document is then output by the document processing device 104 at step 216 in accordance with the calculations made by the page sequencer component 106, the face sequencer component 108, and the sheet sequencer component 110.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A page sequencing system comprising:
means adapted for receiving document data representative of a series of pages for output by an associated document rendering device;
means adapted for receiving device data representative of document output capabilities of the associated document rendering device;
means adapted for receiving instruction data representative of at least one of duplex, collating and number of copies associated the document data;
a page sequencer, the page sequencer including means adapted for generating page sequencing data for associating each page of received document data with a document face in an output thereof by the associated document rendering device in accordance with the document data;
a face sequencer, the face sequencer including means adapted for generating face sequencing data for relative association of document faces in pages of an output of the associated document rendering device in accordance with received instruction data; and
a sheet sequencer, the sheet sequencer including means adapted for generating sheet sequencing data for ordering output of sheets in the associated document rendering device in accordance with received device data.

2. The page sequencing system of claim 1 further comprising metadata means adapted for receiving metadata to at least one of the page sequencer and the face sequencer so as to facilitate respective generation of the page sequencing data and the face sequencing data.

3. The page sequencing system of claim 2 wherein the face sequencer includes means adapted for updating metadata.

4. The page sequencing system of claim 1 wherein the page sequencer includes means adapted for generating the page sequencing data in accordance with at least one of an N-up sort algorithm and a magazine sort algorithm.

5. The page sequencing system of claim 1 wherein the face sequencer includes means adapted for generating face sequencing data in accordance with at least one of data representative of collation operations, number of copies generated, and duplexing operations.

6. The page sequencing system of claim 1 wherein the sheet sequencer includes means adapted for generating parameter data, which parameter data is used in generating the sheet sequencing data in accordance with a plurality of document rendering devices.

7. The page sequencing system of claim 6 wherein the sheet sequencer includes means adapted for generating the sheet sequencing data in accordance with at least one of data representative of input trays, output trays, finishing operations, and capacity of the associated document rendering device.

8. A page sequencing method comprising the steps of:
receiving document data representative of a series of pages for output by an associated document rendering device;
receiving device data representative of document output capabilities of the associated document rendering device;
receiving instruction data representative of at least one of duplex, collating and number of copies associated the document data;
generating page sequencing data, via a page sequencer, for associating each page of received document data with a document face in an output thereof by the associated document rendering device in accordance with the document data;
generating face sequencing data, via a face sequencer, for relative association of document faces in pages of an output of the associated document rendering device in accordance with received instruction data; and
generating sheet sequencing data, via a sheet sequencer, for ordering output of sheets in the associated document rendering device in accordance with received device data.

9. The page sequencing method of claim 8 further comprising the step of receiving metadata to at least one of the page sequencer and the face sequencer so as to facilitate respective generation of the page sequencing data and the face sequencing data.

10. The page sequencing method of claim 9 further comprising the step of updating metadata.

11. The page sequencing method of claim 8 wherein the page sequencing data is generated in accordance with at least one of an N-up sort algorithm and a magazine sort algorithm.

12. The page sequencing method of claim 8 wherein the face sequencing data is generated in accordance with at least one of data representative of collation operations, number of copies generated, and duplexing operations.

13. The page sequencing method of claim 8 further comprising the step of generating parameter data, which parameter data is used in generating the sheet sequencing data in accordance with a plurality of document rendering devices.

14. The page sequencing method of claim 13 wherein sheet sequencing data is generated in accordance with at least one of data representative of input trays, output trays, finishing operations, and capacity of the associated document rendering device.

15. A computer-implemented method for page sequencing comprising the steps of:
receiving document data representative of a series of pages for output by an associated document rendering device;
receiving device data representative of document output capabilities of the associated document rendering device;
receiving instruction data representative of at least one of duplex, collating and number of copies associated the document data;
generating page sequencing data, via a page sequencer, for associating each page of received document data with a document face in an output thereof by the associated document rendering device in accordance with the document data;
generating face sequencing data, via a face sequencer, for relative association of document faces in pages of an output of the associated document rendering device in accordance with received instruction data; and
generating sheet sequencing data, via a sheet sequencer, for ordering output of sheets in the associated document rendering device in accordance with received device data.

16. The computer-implemented method for page sequencing of claim 15 further comprising the step of receiving metadata to at least one of the page sequencer and the face sequencer so as to facilitate respective generation of the page sequencing data and the face sequencing data.

17. The computer-implemented method for page sequencing of claim 16 further comprising the step of updating metadata.

18. The computer-implemented method for page sequencing of claim 15 wherein the page sequencing data is generated in accordance with at least one of an N-up sort algorithm and a magazine sort algorithm.

19. The computer-implemented method for page sequencing of claim 15 wherein the face sequencing data is generated in accordance with at least one of data representative of collation operations, number of copies generated, and duplexing operations.

20. The computer-implemented method for page sequencing of claim 15 further comprising the step of generating parameter data, which parameter data is used in generating the sheet sequencing data in accordance with a plurality of document rendering devices.

21. The computer-implemented method for page sequencing of claim 20 wherein sheet sequencing data is generated in accordance with at least one of data representative of input trays, output trays, finishing operations, and capacity of the associated document rendering device.
